(19) United States
(12) Patent Application Publication
(10) Pub. No.: US 2025/0093792 A1
(43) Pub. Date: Mar. 20, 2025

(54) TONER

(71) Applicant: CANON KABUSHIKI KAISHA, Tokyo (JP)

(72) Inventors: KOZUE URATANI, Shizuoka (JP); YOSHIAKI SHIOTARI, Shizuoka (JP); KOKI INOUE, Shizuoka (JP)

(21) Appl. No.: 18/885,377

(22) Filed: Sep. 13, 2024

(30) Foreign Application Priority Data
Sep. 19, 2023 (JP) 2023-151573

(51) Int. Cl. G03G 9/093

(52) U.S. Cl. CPC G03G 9/09328; G03G 9/09342

(57) ABSTRACT

A toner comprising a toner particle, wherein the toner particle comprises a toner base particle comprising a binder resin, and an organosilicon polymer composite present at a surface of the toner base particle, the organosilicon polymer composite comprises (i) a condensation product of an organosilicon compound, and (ii) a metal compound comprising at least one metal atom selected from the group consisting of aluminum, zirconium and titanium, and the toner satisfies a specific relational equation for the domains of the constituent elements and metal compounds when the toner is analyzed.

### BACKGROUND OF THE INVENTION

### Field of the Invention

The present disclosure relates to toner used in copying machines and printers using an electrophotographic system or electrostatic recording system.

### Description of the Related Art

In recent years, there has been a widespread demand for printers and copying machines to be compact while still having high image quality and longer lifespans. In order to reduce the size of a printer, it is effective to reduce mainly the size of a process cartridge (hereinafter referred to as a cartridge). Cartridges generally include a cleaning container, but in recent years, cleanerless systems including no cleaning container have been proposed. In many printers, the toner (transfer residual toner) remaining on an electrostatic latent image bearing member (hereinafter referred to as a photosensitive member) after a transfer step is scraped off by a cleaning blade or the like and collected as waste toner in a cleaning container. On the other hand, a cleanerless system does not have a cleaning blade or a cleaning container, which can reduce the size of the process cartridge, and the transfer residual toner is collected in a developing apparatus and contributes to development again, which can lead to a longer service life.

However, cleanerless systems also have their own unique disadvantages. One of them is that fillers and additives from media such as paper adhere to a surface of the photosensitive member and are collected as foreign matter in a cartridge developing apparatus. If this foreign matter is mixed in the developing apparatus, provision of charge to the toner is not appropriately performed and image defects are likely to occur. Particularly, in a developing system that negatively charges the toner, when paper containing talc is used as media, if the talc is collected in the developing apparatus, the quantity of charge on the toner decreases. This is because talc has a property of being easily negatively charged, and when talc is rubbed against the toner, the toner tends to become relatively positively charged. As a result, the charge quantity distribution becomes broad, and image defects such as fogging and image defects such as ghosting due to a slow rise-up of charging are likely to occur. In view of such circumstances, there is a demand for toner that can secure stable charging performance even when talc is mixed in the developing apparatus.

In addition, in cleanerless systems, the transfer residual toner is developed once and collected again in the developing apparatus, which increases the number of times the toner is rubbed, and the toner is likely to be deformed due to chipping and cracking. Since the deformed toner has lower charging performance, it is unlikely to be developed, and likely to accumulate in the developing apparatus. When the amount of the deformed toner increases, the flowability of the toner decreases, the toner accumulates between a regulating blade and a development roller, melt adhesion occurs on the regulating blade, and image defects such as white streaks are likely to occur. In order to prevent the increase in an amount of the deformed toner in the developing apparatus, it is important to also charge the deformed toner so as to be developed and discharge the deformed toner from the developing apparatus. In order to achieve this, it is desirable to be able to charge the deformed toner as well.

In order to stably charge the toner, in Japanese Patent Application Publication No. 2021-21789, a method of incorporating an organosilicon polymer composite and a highly conductive metal compound into a shell part of the outmost surface of toner has been proposed. In such a shell configuration, it is possible to improve triboelectric charging performance and inhibit leakage, and maintain excellent charge rising performance and stable charging performance.

Similarly, in Japanese Patent Application Publication No. 2021-21790, a method of incorporating an organosilicon polymer composite and a metal compound into a shell part, and controlling the location of the metal compound, and then applying a charge to the toner using a potential difference generated between a development roller and a regulating blade has also been proposed.

### SUMMARY OF THE INVENTION

However, the present inventors conducted studies and found that, in the methods described in Japanese Patent Application Publication No. 2021-21789 and Japanese Patent Application Publication No. 2021-21790, since the metal compound is exposed and present in the shell part, charge leakage occurs and charging tends to be insufficient in an environment in which stricter charge control is performed. Particularly, the present inventors found that, when talc is mixed in the developing apparatus or when there is a large amount of the deformed toner, there is a problem in that sufficient charging performance cannot be obtained and image defects are likely to occur.

One aspect of the present disclosure is to provide toner which has excellent charging performance and is less likely to cause image defects such as fogging and ghosting, and white streaks caused by blade melt adhesion even when foreign matter such as talc is mixed in a cartridge developing apparatus or when there is a large amount of deformed toner.

According to at least one aspect of the present disclosure, there is provided a toner comprising a toner particle, wherein
the toner particle comprises
   a toner base particle comprising a binder resin, and
   an organosilicon polymer composite present at a surface of the toner base particle,
the organosilicon polymer composite comprises
   (i) a condensation product of an organosilicon compound, and
   (ii) a metal compound comprising at least one metal atom selected from the group consisting of aluminum, zirconium and titanium,
when a ratio of the number of the metal atom to a sum of the numbers of a carbon atom, an oxygen atom, a silicon atom, and the metal atom obtained by X-ray photoelectron spectroscopy on the toner is defined as ME,
in an EDS mapping image of constituent elements of a cross-section of the toner obtained by analyzing with use of energy dispersive X-ray spectroscopy, the cross-section of the toner observed with a transmission electron microscope, a ratio of the number of the metal atom to a sum of the numbers of a silicon atom and the metal atom in a region outside a contour of the toner base particle is defined as MX, and
in the EDS mapping image, in a case where there are domains of the metal compound, and domains with a domain diameter of 10 nm or more are targeted, the number-average diameter of the domains of the metal compound is defined as MN,
   ME is not more than 1.5×10⁻²,
   MX is 1.00×10⁻² to 1.00×10⁻¹, and
   MN is 15 to 80 nm.

According to at least one aspect of the present disclosure, there is provided a toner which has excellent charging performance and is less likely to cause image defects such as fogging and ghosting, and white streaks caused by blade melt adhesion even when foreign matter such as talc is mixed in a cartridge developing apparatus or when there is a large amount of deformed toner.

Further features of the present invention will become apparent from the following description of exemplary embodiments.

### DESCRIPTION OF THE EMBODIMENTS

In the present disclosure, the descriptions of “XX or more and YY or less” or “XX to YY” representing numerical ranges mean numerical ranges including the lower and upper limits, which are endpoints, unless otherwise specified. When numerical ranges are stated stepwise, the upper and lower limits of each numerical range can be combined arbitrarily. In addition, in the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

Hereinafter, the present disclosure will be described in detail.

The inventors conducted studies regarding toner that exhibits excellent charging performance when talc is mixed in a developing apparatus or when the amount of deformed toner increases, and as a result, found that the following toner is effective.

That is, a toner comprising a toner particle, wherein
the toner particle comprises
   a toner base particle comprising a binder resin, and
   an organosilicon polymer composite present at a surface of the toner base particle,
the organosilicon polymer composite comprises
   (i) a condensation product of an organosilicon compound, and
   (ii) a metal compound comprising at least one metal atom selected from the group consisting of aluminum, zirconium and titanium,
when a ratio of the number of the metal atom to a sum of the numbers of a carbon atom, an oxygen atom, a silicon atom, and the metal atom obtained by X-ray photoelectron spectroscopy on the toner is defined as ME,
in an EDS mapping image of constituent elements of a cross-section of the toner obtained by analyzing with use of energy dispersive X-ray spectroscopy, the cross-section of the toner observed with a transmission electron microscope, a ratio of the number of the metal atom to a sum of the numbers of a silicon atom and the metal atom in a region outside a contour of the toner base particle is defined as MX, and
in the EDS mapping image, in a case where there are domains of the metal compound, and domains with a domain diameter of 10 nm or more are targeted, the number-average diameter of the domains of the metal compound is defined as MN,
   ME is not more than 1.5×10⁻²,
   MX is 1.00×10⁻² to 1.00×10⁻¹, and
   MN is 15 to 80 nm.

The inventors consider the toner having such a configuration to exhibit the above effects for the following reasons.

First, the inventors focused on the toner charging process when examining the control of the charging performance of the toner. In the current toner charging process, triboelectric charging is mainly used, but if foreign matter that is easily negatively charged, such as talc, is mixed in a developing apparatus, rubbing between the talc and the toner also occurs when the control member rubs against the toner, and the toner that should be negatively charged tends to be positively charged. As a result, the charge quantity distribution does not become sharp, and there may be toner with a large charge quantity and toner with a low charge quantity. In addition, since triboelectric charging is greatly affected by the flowability of the toner, when the toner is rubbed repeatedly and chipped or cracked and the flowability decreases, the charge quantity is likely to decrease. Accordingly, the charging process using triboelectric charging is insufficient in consideration of accurate charge control. Therefore, considering that accurate charge control is required in a stricter environment, a fundamentally different charging process is required.

Therefore, the inventors examined injection charging, which is a charging process different from triboelectric charging. Injection charging is a charging process in which a charge is applied to the toner by a potential difference generated between a control member and a development roller in a developing apparatus. If the toner can have injection charging performance, in which charging is by a potential difference, in addition to conventional triboelectric charging performance, charging of the toner can be controlled more accurately.

Incidentally, it is known that, when the toner is in an electric field, as shown in the following Formula (1), the charge quantity changes according to the potential difference.

$$Q = C \cdot V \qquad ( 1 )$$

(in Formula (1), Q is the charge quantity of the toner, C is the electrostatic capacitance of the toner, and V is the potential difference)

In this case, the proportionality constant C is the electrostatic capacitance of the toner, and can be represented by the following Formula (2).

$$C = {ε}_{r} \cdot {C}_{0} \qquad ( 2 )$$

(in Formula (2), εᵣ is the relative dielectric constant of the toner, and C₀ is the electrostatic capacitance of a vacuum)

That is, when the relative dielectric constant εᵣ of the toner is larger, the quantity of charge that can be applied by the potential difference is larger.

As described above, in the injection charging process, the quantity of charge that can be applied to the toner can be controlled by controlling the relative dielectric constant εᵣ of the toner. That is, when the dielectric constant εᵣ increases, since a large quantity of charge can be applied to the toner by the potential difference generated between the control member and the development roller, even if foreign matter such as talc enters, the toner can be sufficiently charged. In addition, the amount of triboelectric charge of the toner deformed due to cracking or chipping decreases as the flowability decreases, but it is possible to apply a charge to such toner. As a result, the deformed toner is also developed, and it is possible to prevent the concentration of the deformed toner in the developer container from increasing.

The inventors found that, regarding the configuration of the toner, when the toner contains a toner particle, the toner particle includes a toner base particle containing a binder resin and an organosilicon polymer composite at the surface of the toner base particle, and the organosilicon polymer composite includes (i) a condensation product of an organosilicon compound, and (ii) a metal compound containing at least one metal atom selected from the group consisting of aluminum, zirconium and titanium, it is possible to increase the relative dielectric constant εᵣ of the toner. The reason for this is thought to be as follows.

In order to increase the dielectric constant εᵣ, it is effective to selectively use toner constituent materials with different volume resistivities. The dielectric constant εᵣ is an index of the ease of polarization of an insulator. When a high-resistance material and a low-resistance material are provided together, in an electric field, a charge bias occurs first in the low-resistance material, which induces and increases the polarization of the high-resistance material. In this manner, when an organosilicon polymer composite having a lower resistance than a binder resin is present at the surface of toner base particles containing a binder resin as a high-resistance material, the polarization of the binder resin is induced in an electric field, and as a result, the relative dielectric constant εᵣ of the toner can be increased. For example, styrene resins are suitably used as binder resins for toners, and the volume resistivity of polystyrene is about 1.0×10¹⁴ Ω·m. On the other hand, although the organosilicon compound is classified as an insulator, it has a lower resistance than the binder resin, and for example, the volume resistivity of silicon rubber is about 1.0×10¹² to 1.0×10¹³ Ω·m. In this manner, when materials with different resistivities are selectively used, it is possible to control the dielectric constant εᵣ.

In addition, the organosilicon polymer composite according to one aspect of the present disclosure includes (i) a condensation product of an organosilicon compound and (ii) a metal compound containing at least one metal atom selected from the group consisting of aluminum, zirconium and titanium (hereinafter referred to as a specific metal atom). These metal atoms have a valence of 3 or higher, and have a large amount of free electrons. When a metal compound containing such metal atoms is in an electric field, free electrons immediately move, and a large charge bias occurs in the metal compound. When such a metal compound and a condensation product of an organosilicon compound are provided together, the polarization of the condensation product of the organosilicon compound in an electric field is induced, and the dielectric constant εᵣ can be further increased.

Thus, toner with a large dielectric constant εᵣ can store a large quantity of charge at the surface of the toner in an electric field. For example, since polyvalent metal salts used in Japanese Patent Application Publication No. 2021-21789 and Japanese Patent Application Publication No. 2021-21790 have excellent conductivity, when they are contained in an organosilicon polymer composite together with a condensation product of an organosilicon compound, the dielectric constant εᵣ can be increased.

On the other hand, if a metal compound is exposed and present at the surface of the toner, free electrons in the metal compound leak to the development roller or the charge stored at the surface of the toner leaks due to a potential difference through the metal compound, and the charge quantity decreases.

When a highly hydrophobic organosilicon condensation product and a less hydrophobic polyvalent metal salt as used in Japanese Patent Application Publication No. 2021-21789 and Japanese Patent Application Publication No. 2021-21790 are provided together, the polyvalent metal salt is likely to be exposed and present at the surface of the organosilicon polymer composite or the surface of the toner base particles. In such a case, in an environment in which charging performance is stricter, since the charge leaks from the toner, image defects due to insufficient charging are likely to occur. Therefore, when a highly conductive metal compound is used, it is necessary to prevent exposure of metal atoms.

Therefore, when the ratio of the number of specific metal atoms to the sum of the numbers of a carbon atom, an oxygen atom, a silicon atom, and specific metal atoms (at least one metal atom selected from among aluminum, zirconium and titanium) obtained by X-ray photoelectron spectroscopy (ESCA) on the toner is defined as ME, it is important that ME be 1.5×10⁻² or less.

In addition, the cross-section of the toner observed under a scanning transmission electron microscope (STEM) is analyzed using an energy dispersive X-ray spectrometer (EDS) to obtain an EDS mapping image of constituent elements of the cross-section of the toner. In the EDS mapping image, when the ratio of the number of specific metal atoms to the sum of the numbers of silicon atoms and specific metal atoms in a region outside the contour of the toner base particle is defined as MX (the number of specific metal atoms/sum of the numbers of silicon atoms and specific metal atoms), it is important that MX be from 1.00×10⁻² to 1.00×10⁻¹.

ME indicates the proportion of specific metal atoms present at the surface and in the vicinity of the surface of the toner. A lower ME value indicates fewer specific metal atoms present at the surface and in the vicinity of the surface. When the ME value is 1.5×10⁻² or less, charge leakage is highly inhibited. When the ME value exceeds 1.5×10⁻², since it becomes difficult to control charge leakage, image defects due to insufficient charging are likely to occur.

ME is preferably 1.2×10⁻³ to 1.2×10⁻², and more preferably 2.5×10⁻³ to 1.0×10⁻².

In order to control ME and MX to be within the above numerical ranges, it is effective to treat the surface of metal compound particles with an organosilicon compound. Details will be described below.

In addition, the amount of metal atoms contained in the organosilicon polymer composite is also important. The “region outside the contour of the toner base particle” in the EDS mapping image of the cross-section of the toner indicates the organosilicon polymer composite present at the surface of the toner base particles. MX indicates a specific metal atom that can be detected inside the organosilicon polymer composite, and when the MX value is 1.00×10⁻² or more, the polarization of the condensation product of the organosilicon compound in an electric field is induced. Therefore, the relative dielectric constant εᵣ of the toner can be sufficiently controlled, and a sufficient charge quantity can be obtained.

On the other hand, the MX value exceeding 1.00×10⁻¹ means that the amount of metal atoms contained in the organosilicon polymer composite is large. Therefore, the number of metal atoms exposed and present at the surface of the toner increases, and even if not exposed, the number of metal atoms present in the vicinity of the surface within the organosilicon polymer composite increases. When the number of metal atoms present in the vicinity of the surface increases, since electrical breakdown occurs and charge leakage is likely to occur, it is difficult to accurately control charging performance.

MX is preferably 2.00×10⁻² to 8.00×10⁻², and more preferably 2.50×10⁻² to 7.60×10⁻².

In addition, it is also important to control the domain diameter of the metal compound in the organosilicon polymer composite. In the toner according to one aspect of the present disclosure, in the EDS mapping image, if there are domains of the metal compound, domains with a domain diameter of 10 nm or more are targeted, and the number-average diameter of the domains of the metal compound is defined as MN, MN is 15 nm or more. Since the amount of free electrons in the metal compound is proportional to the size of the metal compound, when MN is 15 nm or more, a large charge bias occurs when the free electrons move within the metal compound under an electric field. Therefore, the polarization of the condensation product of the organosilicon compound can be effectively performed.

On the other hand, when MN exceeds 80 nm, even if the metal compound is encapsulated in the organosilicon polymer composite, it is likely to be detached by rubbing in the developer container, and the charging performance changes during use. As a result, image defects are likely to occur. A more preferable range for MN is 20 nm to 50 nm or less, and a still more preferable range is 30 nm to 35 nm.

MN can be controlled by the particle size of the metal compound contained in the organosilicon polymer composite.

The ME and MX values satisfying the above ranges means that a certain amount of metal atoms are present inside the organosilicon polymer composite, but only a small amount of metal atoms are present at the surface and in the vicinity of the surface of the toner. In addition, the MN value satisfying the above range means that a part of the metal compound is encapsulated as a domain in the condensation product of the organosilicon compound. When the toner is configured in this manner, the charging performance of the toner can be appropriately controlled, and leakage can be inhibited.

In the toner according to the present disclosure, the coverage ratio of the toner base particles with the organosilicon polymer composite is preferably from 35 area % to 70 area %.

As described above, when the organosilicon polymer composite having a lower resistance than the binder resin is present at the surface of toner base particles containing a binder resin as an insulator, the polarization of the binder resin is induced in an electric field, and as a result, the relative dielectric constant εᵣ of the toner can increase. As a result, when the toner is in an electric field, it can store a large quantity of charge on its surface. When the coverage ratio of the toner base particles with the organosilicon polymer composite is 35 area % or more, this is preferable because the polarization of the binder resin is easily induced. On the other hand, when the coverage ratio is 70 area % or less, the toner is less likely to be charged up, and accurate charge control becomes easier. The coverage ratio is more preferably 40 area % to 65 area % and particularly preferably 45 area % to 60 area %.

The coverage ratio of toner base particles can be adjusted by the amount of the organosilicon compound added and the pH. The coverage ratio can be increased by increasing the amount of the organosilicon compound added. On the other hand, the coverage ratio can be reduced by reducing the amount of the organosilicon compound added. In addition, when the pH increases, the condensation of the organosilicon compound proceeds more easily, and the condensation within the organosilicon compound occurs not only at the surface of toner base particles but also in water. As a result, the coverage ratio of the organosilicon polymer composite at the surface of toner base particles can be reduced.

The content of the organosilicon polymer composite with respect to 100.0 parts by mass of toner base particles is preferably 3 parts by mass to 10 parts by mass.

The toner according to the present disclosure contains a metal compound containing at least one metal atom selected from the group consisting of aluminum, zirconium and titanium, and among these metal atoms, titanium is particularly preferable.

The content of the metal compound with respect to 100.0 parts by mass of toner base particles is preferably 0.05 parts by mass to 1.0 part by mass.

The volume resistivity (20° C.) of each metal is 2.8×10⁻⁸ (Ω·m) for aluminum, 40.6×10⁻⁸ (Ω·m) for zirconium, and 53.3×10⁻⁸ (Ω·m) for titanium. A metal compound containing these metal atoms is present inside the organosilicon polymer composite, but when the metal compound is located in the vicinity of the surface of the organosilicon polymer composite, if the volume resistivity is too low, electrical breakdown occurs in an electric field, and charge leakage is likely to occur. Among these, titanium has the highest volume resistivity, and is preferably used because charging performance can be controlled without being significantly affected by the location of the metal compound in the organosilicon polymer composite.

Specific examples of metal compounds containing titanium atoms include titanium oxides such as titanium dioxide, titanate compounds such as potassium titanate, calcium titanate, strontium titanate, and barium titanate, and reaction products of titanium with polyhydric acids. Specific examples of polyhydric acids include inorganic acids such as phosphoric acid (trivalent), carbonic acid (divalent), and sulfuric acid (divalent); and organic acids such as dicarboxylic acids (divalent) and tricarboxylic acids (trivalent). Specific examples of organic acids include dicarboxylic acids such as oxalic acid, malonic acid, succinic acid, glutaric acid, adipic acid, fumaric acid, maleic acid, pimelic acid, suberic acid, azelaic acid, sebacic acid, phthalic acid, isophthalic acid, and terephthalic acid; and tricarboxylic acids such as citric acid, aconitic acid, and trimellitic anhydride. Examples of reaction products of titanium with polyhydric acids include titanium phosphate compounds, titanium sulfate compounds, titanium carbonate compounds, and titanium oxalate compounds.

Among these, titanium dioxide and reaction products of titanium with polyhydric acids are preferable because they have a high affinity with the condensation product of the organosilicon compound. As will be described below, when an organosilicon polymer composite is formed at the surface of toner base particles, there is a method in which an organosilicon compound is hydrolyzed and then introduced into an aqueous medium in which the toner base particles are dispersed. Titanium dioxide has high hydrophilicity and the reaction products of titanium with polyhydric acids also have high hydrophilicity because polyhydric acids are ionized in water. These metal compounds have a high affinity with the hydrolysate of organosilicon compounds, and the surface of the metal compound can be treated with the condensation product of the organosilicon compound. As a result, the metal compound is likely to be present in the organosilicon polymer composite without being exposed.

That is, the metal compound is preferably at least one metal compound selected from the group consisting of titanium dioxide and reaction products of titanium with polyhydric acids.

Here, titanium dioxide is more preferably selected because it has a large amount of free electrons and tends to have a large charge bias under an electric field. Thereby, the polarization of the condensation product of the organosilicon compound is induced, and the dielectric constant εᵣ can be further increased.

Hereinafter, materials constituting the toner will be described.

### Organosilicon Compound

The organosilicon polymer composite present at the surface of the toner base particles contains a condensation product of an organosilicon compound. The content of the organosilicon compound with respect to 100.0 parts by mass of toner base particles is preferably 10 parts by mass to 20 parts by mass.

As the organosilicon compound, any known organosilicon compound can be used without any particular limitation. It is particularly preferable that, when the organosilicon compound is condensed, it becomes an organosilicon polymer having a structure represented by the following Formula (I).

R—SiO_{3/2} (I)

(In Formula (I), R is an alkyl group (having preferably 1 to 8 carbon atoms and more preferably 1 to 6 carbon atoms), an alkenyl group (having preferably 1 to 6 carbon atoms and more preferably 1 to 4 carbon atoms), an acyl group (having preferably 1 to 6 carbon atoms and more preferably 1 to 4 carbon atoms), an aryl group (having preferably 6 to 14 carbon atoms and more preferably 6 to 10 carbon atoms) or a methacryloxyalkyl group.)

Formula (I) indicates that the condensation product of the organosilicon compound has an organic group and a silicon polymer moiety. Thereby, in the condensation product of the organosilicon compound having a structure represented by Formula (I), since the organic group has an affinity for toner base particles, it is strongly fixed to the toner base particles. In addition, when the organosilicon compound of Formula (I) is condensed to increase the strength, this provides excellent durability and can prevent the toner from being chipped, cracked, and deformed. In Formula (I), R is preferably an alkyl group having 1 to 6 carbon atoms such as a methyl group, a propyl group, or an n-hexyl group, a vinyl group, a phenyl group, or a methacryloxypropyl group, and more preferably an alkyl group having 1 to 6 carbon atoms or a vinyl group. Since the organosilicon polymer having the above structure has both hardness and flexibility due to the controlled molecular mobility of the organic group, even when used for a long time, toner deterioration is minimized and excellent performance is exhibited.

As the organosilicon compound for obtaining the organosilicon polymer, any known organosilicon compound can be used without any particular limitation. Among these, at least one selected from the group consisting of organosilicon compounds represented by the following Formula (II) is preferable.

R—Si—(Ra)₃ (II)

(in Formula (II), Ra's each independently represent a halogen atom or an alkoxy group (having preferably 1 to 4 carbon atoms and more preferably 1 to 3 carbon atoms), R represents each independently an alkyl group (having preferably 1 to 8 carbon atoms and more preferably 1 to 6 carbon atoms), an alkenyl group (having preferably 1 to 6 carbon atoms and more preferably 1 to 4 carbon atoms), an aryl group (having preferably 6 to 14 carbon atoms and more preferably 6 to 10 carbon atoms), an acyl group (having preferably 1 to 6 carbon atoms and more preferably 1 to 4 carbon atoms) or a methacryloxyalkyl group).

Specific examples of an organosilicon compound represented by the formula (II) include trifunctional silane compounds such as: trifunctional methylsilane compounds such as methyltrimethoxysilane, methyltriethoxysilane, methyldiethoxymethoxysilane, and methylethoxydimethoxysilane; trifunctional silane compounds such as ethyltrimethoxysilane, ethyltriethoxysilane, propyltrimethoxysilane, propyltriethoxysilane, butyltrimethoxysilane, butyltriethoxysilane, hexyltrimethoxysilane, and hexyltriethoxysilane; trifunctional phenylsilane compounds such as phenyltrimethoxysilane and phenyltriethoxysilane; trifunctional vinylsilane compounds such as vinyltrimethoxysilane and vinyltriethoxysilane; trifunctional allylsilane compounds such as allyltrimethoxysilane, allyltriethoxysilane, allyldiethoxymethoxysilane, and allylethoxydimethoxysilane; and trifunctional γ-methacryloxypropylsilane compounds such as γ-methacryloxypropyltrimethoxysilane, γ-methacryloxypropyltriethoxysilane, γ-methacryloxypropyldiethoxymethoxysilane, and γ-methacryloxypropylethoxydimethoxysilane.

In Formula (II), R is preferably an alkyl group having 1 to 6 carbon atoms such as a methyl group, a propyl group, or an n-hexyl group, a vinyl group, a phenyl group, or a methacryloxypropyl group, and more preferably an alkyl group having 1 to 6 carbon atoms or a vinyl group. Therefore, it is possible to obtain an organosilicon polymer that satisfies a preferable range of Formula (I). In addition, Ra is preferably an alkoxy group because it has appropriate reactivity in an aqueous medium and thus an organosilicon polymer can be stably obtained, and particularly, Ra is more preferably a methoxy group or an ethoxy group.

### Binder Resin

The toner base particle contains a binder resin. As the binder resin, a known resin can be used without any particular limitation. Specific examples thereof include vinyl-based resins, polyester resins, polyurethane resins, and polyamide resins. Preferably, the binder resin contains a vinyl-based resin. Examples of the polymerizable monomer that can be used for producing the vinyl-based resin include styrene-based monomers such as styrene and α-methylstyrene; acrylic acid esters such as methyl acrylate and butyl acrylate; methacrylic acid esters such as methyl methacrylate, 2-hydroxyethyl methacrylate, t-butyl methacrylate, and 2-ethylhexyl methacrylate; unsaturated carboxylic acids such as acrylic acid and methacrylic acid; unsaturated dicarboxylic acids such as maleic acid; unsaturated dicarboxylic anhydrides such as maleic anhydride; nitrile-based vinyl monomers such as acrylonitrile; halogen-based vinyl monomers such as vinyl chloride; and nitro-based vinyl monomers such as nitrostyrene.

### Colorant

The toner base particle may contain a colorant. As the colorant, conventionally known pigments and dyes of each color of black, yellow, magenta, and cyan, and other colors, magnetic bodies, and the like can be used without particular limitation.

Examples of the black colorant include black pigments such as carbon black.

Examples of the yellow colorant include yellow pigments and yellow dyes such as a monoazo compound; a disazo compound; a condensed azo compound; an isoindolinone compound; a benzimidazolone compound; an anthraquinone compound; an azo metal complex; a methine compound; and an allylamide compound.

Specific examples thereof include C.I. Pigment Yellow 74, 93, 95, 109, 111, 128, 155, 174, 180, and 185, and C.I. Solvent Yellow 162.

Examples of the magenta colorant include magenta pigments and magenta dyes such as a monoazo compound; a condensed azo compound; a diketopyrrolopyrrole compound; an anthraquinone compound; a quinacridone compound; a basic dye chelate compound; a naphthol compound; a benzimidazolone compound; a thioindigo compound, and a perylene compound.

Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, and 269, and C.I. Pigment Violet 19.

Examples of the cyan colorant include cyan pigments and cyan dyes such as a copper phthalocyanine compound and a derivative thereof, an anthraquinone compound, and a basic dye chelate compound.

Specific examples thereof include C.I. Pigment Blue 1, 7, 15, 15:1, 15:2, 15:3, 15:4, 60, 62, and 66.

A content of the colorant is preferably from 1.0 part by mass to 20.0 parts by mass with respect to 100.0 parts by mass of the binder resin or the polymerizable monomer.

### Wax

The toner base particle may contain a wax. As the wax, a conventionally known wax can be used without particular limitation. Specific examples thereof include esters of a monohydric alcohol and a monocarboxylic acid, such as behenyl behenate, stearyl stearate, and palmityl palmitate; esters of a divalent carboxylic acid and a monoalcohol, such as dibehenyl sebacate; esters of a dihydric alcohol and a monocarboxylic acid, such as ethylene glycol distearate and hexanediol dibehenate; esters of a trihydric alcohol and a monocarboxylic acid, such as glycerin tribehenate; esters of a tetrahydric alcohol and a monocarboxylic acid, such as pentaerythritol tetrastearate and pentaerythritol tetrapalmitate; esters of a hexahydric alcohol and a monocarboxylic acid, such as dipentaerythritol hexastearate and dipentaerythritol hexapalmitate; esters of a polyfunctional alcohol and a monocarboxylic acid, such as polyglycerin behenate; natural ester waxes such as carnauba wax and rice wax; petroleum-based hydrocarbon wax such as paraffin wax, microcrystalline wax, and petrolatum, and derivatives thereof; hydrocarbon wax obtained by Fischer-Tropsch method and derivatives thereof; polyolefin-based hydrocarbon wax such as polyethylene wax and polypropylene wax, and derivatives thereof; higher aliphatic alcohol; fatty acids such as stearic acid and palmitic acid; and acid amide wax.

From the viewpoint of releasability, the content of the wax is preferably from 1.0 parts by mass to 30.0 parts by mass, and more preferably from 5.0 parts by mass to 20.0 parts by mass, based on 100.0 parts by mass of the binder resin or the polymerizable monomer.

### Charge Control Agent

The toner may contain a charge control agent. As the charge control agent, a known charge control agent can be used without particular limitation.

Specific examples thereof include, as a negative charge control agent, a metal compound of an aromatic carboxylic acid such as salicylic acid, alkylsalicylic acid, dialkylsalicylic acid, naphthoic acid, or dicarboxylic acid or a polymer or copolymer having the metal compound of the aromatic carboxylic acid; a polymer or copolymer having a sulfonic acid group, a sulfonate group, or a sulfonic acid ester group; a metal salt or a metal complex of an azo dye or an azo pigment; and a boron compound, a silicon compound, and calixarene.

A content of the charge control agent is preferably from 0.01 parts by mass to 5.0 parts by mass with respect to 100.0 parts by mass of the binder resin or the polymerizable monomer.

### External Additive

Toner particles have excellent properties such as flowability even without an external additive because they contain an organosilicon polymer composite. However, for further improvement, an external additive may be added to the toner particles. As the external additive, conventionally known external additives can be used without any particular limitation. Specific examples thereof include silica base material fine particles such as wet-process silica and dry-process silica and silica fine particles obtained by performing a surface treatment on silica base material fine particles with a treatment agent such as a silane coupling agent, a titanium coupling agent, or a silicone oil; and resin fine particles such as vinylidene fluoride fine particles and polytetrafluoroethylene fine particles. The content of the external additive with respect to 100.0 parts by mass of toner particles is preferably from 0.1 parts by mass to 5.0 parts by mass.

Next, a method of producing toner will be described below.

The method of producing toner is not particularly limited, and known methods can be used. It is preferable that toner base particles be produced in an aqueous medium and an organosilicon polymer composite be formed at the surface of toner base particles.

### Step of Producing Toner Base Particles

The method of producing toner base particles is not particularly limited, and a suspension polymerization method, a dissolution suspension method, an emulsion aggregation method, a pulverization method and the like can be used. Among these, the suspension polymerization method is preferable. As an example, a method of obtaining toner base particles by the suspension polymerization method will be described below.

First, polymerizable monomers that can produce a binder resin, and as necessary, various additives are mixed, and the materials are dissolved or dispersed using a disperser to prepare a polymerizable monomer composition. Examples of various additives include colorants, waxes, charge control agents, polymerization initiators, and chain transfer agents. Examples of dispersers include homogenizers, ball mills, colloid mills, and ultrasonic dispersers.

Next, the polymerizable monomer composition is introduced into an aqueous medium containing sparingly water-soluble inorganic fine particles and drops of the polymerizable monomer composition are prepared using a high-speed disperser such as a high-speed stirring machine or an ultrasonic disperser (granulation step).

Then, the polymerizable monomer in the drops is polymerized to obtain toner base particles (polymerization step).

The polymerization initiator may be mixed when the polymerizable monomer composition is prepared, or may be mixed into the polymerizable monomer composition immediately before drops are formed in an aqueous medium. In addition, during granulation of drops or after granulation is completed, that is, immediately before the polymerization reaction starts, as necessary, the polymerization initiator that is dissolved in polymerizable monomers and other solvents can be added.

In order to remove unreacted polymerizable monomers and the like from the resin particle dispersed solution after the polymerization step is completed, volatile components may be removed (distillation step). The distillation step is performed by heating and stirring the resin particle dispersed solution in a stirring chamber with a stirring unit. In this case, heating conditions are appropriately adjusted in consideration of the vapor pressure of components to be removed, such as polymerizable monomers, and heating can be performed under a normal pressure or reduced pressure.

After the distillation step is completed, a cooling step may be performed in order to lower the solution temperature. Depending on the conditions of the cooling step, the crystal state and location of the wax in the toner can be controlled.

### Organosilicon Polymer Composite Formation Step

The organosilicon polymer composite is composed of a condensation product of an organosilicon compound and a metal compound. Examples of methods of forming a condensation product of an organosilicon compound at the surface of toner base particles include a method of condensing an organosilicon compound in an aqueous medium in which the toner base particles are dispersed. In addition, a method of adhering an organosilicon polymer onto toner base particles in a dry or wet manner with a mechanical external force may be exemplified. Among these, a method of condensing an organosilicon compound in an aqueous medium in which the toner base particles are dispersed is preferable because it is possible to firmly fix the toner base particles and the condensation product of the organosilicon compound.

In this method, in order to easily control the condensation reaction and reduce the amount of the organosilicon compound remaining in the toner base particle dispersed solution, it is preferable that the organosilicon compound be hydrolyzed and then added to an aqueous medium. In addition, when the organosilicon compound is hydrolyzed, the metal compound is introduced into the organosilicon compound, the organosilicon compound is hydrolyzed with stirring, and the organosilicon compound is condensed at the surface of the metal compound to perform a surface treatment. In this manner, when the hydrolyzed solution of the organosilicon compound containing a metal compound is introduced into an aqueous medium, an organosilicon polymer composite is formed by encapsulating a metal compound at the surface of the toner base particles. In this case, the ratio of the organosilicon compound to the metal compound is preferably 40:0.30 to 40:6.00 (parts by mass).

That is, the method of producing toner preferably includes a step of introducing a polymerizable monomer composition into an aqueous medium containing sparingly water-soluble inorganic fine particles and preparing drops of the polymerizable monomer composition using a high-speed disperser such as a high-speed stirring machine or an ultrasonic disperser (granulation step), a step of polymerizing polymerizable monomers in the drops to obtain toner base particles (polymerization step), and a step of condensing an organosilicon compound in the aqueous medium in which the toner base particles are dispersed (organosilicon polymer composite formation step).

Hydrolysis is preferably performed in an aqueous medium in which the pH is adjusted using a known acid or base. It is known that the hydrolysis of the organosilicon compound is pH-dependent, and it is preferable to appropriately change that pH when the hydrolysis is performed depending on the type of the organosilicon compound. For example, when methyltriethoxysilane is used as the organosilicon compound, the pH of the aqueous medium is preferably from 2.0 to 6.0.

The temperature during hydrolysis is preferably 40° C. to 70° C., and the time is preferably 30 minutes to 180 minutes.

Specific examples of the acid for adjusting the pH include an inorganic acid such as hydrochloric acid, hydrobromic acid, hydroiodic acid, hypochlorous acid, chlorous acid, chloric acid, perchloric acid, hypobromous acid, bromous acid, bromic acid, perbromic acid, hypoiodous acid, iodous acid, iodic acid, periodic acid, sulfuric acid, nitric acid, phosphoric acid, and boric acid, and an organic acid such as acetic acid, citric acid, formic acid, gluconic acid, lactic acid, oxalic acid, and tartaric acid.

Specific examples of the base for adjusting the pH include a hydroxide of alkali metal, such as potassium hydroxide, sodium hydroxide, and lithium hydroxide and an aqueous solution thereof, a carbonate of alkali metal, such as potassium carbonate, sodium carbonate, and lithium carbonate and an aqueous solution thereof, a sulfate of alkali metal, such as potassium sulfate, sodium sulfate, and lithium sulfate and an aqueous solution thereof, a phosphate of alkali metal, such as potassium phosphate, sodium phosphate, and lithium phosphate and an aqueous solution thereof, a hydroxide of alkaline earth metal, such as calcium hydroxide and magnesium hydroxide and an aqueous solution thereof, and amines such as ammonia and triethylamine.

In the organosilicon polymer composite formation step, the pH when the metal compound and the organosilicon compound (or a hydrolysate thereof) are mixed into the toner base particle dispersed solution is preferably a pH at which condensation of the organosilicon compound does not easily proceed, and for example, the pH is preferably 2.0 to 6.0 and more preferably 4.0 to 6.0. Thus, it is preferable to mix the metal compound and the organosilicon compound (a hydrolysate thereof) into the toner base particle dispersed solution and control the pH. In the organosilicon polymer composite formation step, the pH is preferably 8.5 to 10.5, and the pH is more preferably 9.0 to 10.0.

In addition, generally, when the metal compound has a smaller particle size, the particles strongly aggregate, and it is difficult to perform a uniform surface treatment. When the surface treatment is not performed uniformly, the metal compound is likely to be exposed from the surface of the organosilicon polymer composite. Therefore, the number-average diameter of the metal compound is preferably 10 nm or more and more preferably 20 to 35 nm.

ME, MX, and MN can be arbitrarily controlled by adjusting the conditions such as the particle size of each material and the amount of each material added.

Specifically, ME can be increased by decreasing the particle size of the metal compound particles. ME can be decreased by increasing the particle size of the metal compound.

MX can be increased by increasing the amount of the metal compound added or by decreasing the amount of the organosilicon compound added. MX can be decreased by decreasing the amount of the metal compound added or by increasing the amount of the organosilicon compound added.

In addition, MN can be increased by increasing the particle size of the metal compound. MN can be decreased by decreasing the particle size of the metal compound.

### Solid/Liquid Separation Step, Washing Step, and Drying Step

In order to remove the dispersion stabilizer adhered to the surface of the toner particles, the toner particle-dispersed solution may be treated with an acid or alkali. After the dispersion stabilizer is removed from the toner particles, the toner particles are separated from the aqueous medium by a general solid/liquid separation method, but in order to completely remove the acid or alkali and the dispersion stabilizer component dissolved therein, it is preferable to add water again to wash the toner particles. This washing step is repeated several times and after washing is sufficiently performed, solid/liquid separation can be performed again to obtain toner particles. The obtained toner particles may be dried by a known drying method as necessary.

The weight-average particle size of the obtained toner particles is preferably from 3 μm to 10 μm and more preferably from 4 μm to 8 μm. The weight-average particle size of the toner particles can be controlled according to the amount of the dispersion stabilizer added used in the granulation step.

### External Addition Step

An external additive may be added to the obtained toner particles in order to improve flowability, charging performance, blocking properties and the like. The external addition step is performed by putting the external additive and the toner particles into a mixing device such as an FM mixer (commercially available from Nippon Coke & Engineering Co., Ltd.), and sufficiently mixing them.

Next, methods of measuring physical properties will be described. Method of Measuring Ratio (ME) of Number of Specific Metal Atoms to Sum of Numbers of Carbon Atoms, Oxygen Atoms, Silicon Atoms, and Specific Metal Atoms

Using the following device under the following conditions, the surface of the toner is subjected to element analysis, and the obtained numerical value is analyzed to calculate the atom number ratio.
Measurement device: Quantum 2000 (product name, commercially available from ULVAC-PHI, Inc.)
X-ray source: Al Kα
Xray Setting: 100 μmφ (25 W (15 KV))
Photoelectron take-off angle: 45 degrees
Neutralization electron gun: 20 μA, 1 V
Ar ion gun: 7 mA, 10 V
Number of Sweeps: 30 times for Si, 10 times for C, 20 times for O, 50 times for Ti, 50 times for Al, and 50 times for Zr
Analysis region: 300×200 μm
Pass Energy: 58.70 eV
Step size: 1.25 eV
Analysis software: Maltipak (commercially available from PHI)

From the measured peak intensity of each element, the atom concentration (atom %) of each element is calculated using a relative sensitivity factor provided from PHI. Based on the calculation result, the ratio of the number of specific metal atoms to the sum of the numbers of carbon atoms, oxygen atoms, silicon atoms, and specific metal atoms is calculated. Here, when two or more types of specific metal atoms are contained, the ratio of the sum of the numbers of these metal atoms is calculated.

That is, ME=(sum of number of specific metal atoms)/(sum of numbers of carbon atoms, oxygen atoms, silicon atoms, and specific metal atoms).

### Method of Measuring Weight-Average Particle Size (D4) and Number-Average Particle Size (D1)

The weight-average particle size (D4) of the toner, toner particles, or toner base particles (hereinafter referred to as toner, etc.) is calculated as follows.

As a measuring device, precision particle diameter distribution measuring device “Coulter Counter Multisizer 3” (registered trademark, manufactured by Beckman Coulter, Inc.), which is based on a pore electrical resistance method and equipped with a 100 μm aperture tube is used.

For the setting of measurement conditions and the analysis of measurement data, dedicated software “Beckman Coulter Multisizer 3 Version 3.51” (manufactured by Beckman Coulter, Inc.) is used. The measurement is performed at the number of effective measurement channels of 25,000 and analyzing the measurement data. For the electrolytic aqueous solution used for measurement, a solution in which special grade sodium chloride is dissolved in ion-exchanged water so that the concentration is about 1.0% by mass, for example, “ISOTON II” (manufactured by Beckman Coulter, Inc.) can be used. Before performing the measurement and analysis, the dedicated software is set as follows.

At the “Change Standard Measurement Method (SOM) Screen” of the dedicated software, the total number of counts in control mode is set to 50,000 particles, the number of measurements is set to 1, and a value obtained using “Standard Particle 10.0 μm” (manufactured by Beckman Coulter Co., Ltd.) is set as the Kd value. The threshold and noise level are automatically set by pressing the threshold/noise level measurement button. Also, the current is set to 1600 μA, the gain is set to 2, the electrolytic solution is set to ISOTON II, and the flash of aperture tube after measurement is checked. At the “Pulse to Particle Diameter Conversion Setting Screen” of the dedicated software, the bin interval is set to logarithmic particle diameter, the particle diameter bin is set to a 256 particle diameter bin, and the particle diameter range is set to from 2 μm to 60 μm.

The specific measurement method is as follows.

(1) 200.0 mL of the electrolytic aqueous solution is placed in a 250 mL round-bottom glass beaker exclusively provided for Multisizer 3, the beaker is set on a sample stand, and a stirrer rod is stirred counterclockwise at 24 revolutions/second. Then, the dirt and air bubbles inside the aperture tube are removed using the “Flush Aperture Tube” function of the dedicated software.

(2) 30.0 mL of the electrolytic aqueous solution is placed in a 100 mL flat-bottomed glass beaker, and 0.3 mL of a diluent obtained by 3-fold by mass dilution of “CONTAMINON N” (a 10% by mass aqueous solution of a neutral detergent for washing precision measuring instruments at pH 7, which consists of a nonionic surfactant, an anionic surfactant, and an organic builder, manufactured by Wako Pure Chemical Industries, Ltd.) as a dispersing agent with ion-exchanged water is added thereto.

(3) 3.3 L of ion-exchanged water is placed in a water tank of an ultrasonic disperser “Ultrasonic Dispersion System Tetora 150” (manufactured by Nikkaki Bios Co., Ltd.) having an electrical output of 120 W and containing two oscillators with an oscillation frequency of 50 kHz that are built in with a phase shift of 180 degrees, and 2 mL of the CONTAMINON N is added to the water tank.

(4) The beaker of (2) is set in the beaker fixing hole of the ultrasonic disperser and the ultrasonic disperser is operated. The height position of the beaker is adjusted so that the resonance state of the liquid level of the electrolytic aqueous solution in the beaker is maximized.

(5) While the electrolytic aqueous solution in the beaker in (4) above is being irradiated with ultrasonic waves, 10 mg of toner, etc. is added little by little to the electrolytic aqueous solution and dispersed. Then, the ultrasonic dispersion treatment is continued for another 60 sec. In the ultrasonic dispersion, the temperature of water in the water tank is appropriately adjusted to from 10° C. to 40° C.

(6) The electrolytic aqueous solution of (5) in which the toner, etc. is dispersed is dropped using a pipette into the round-bottomed beaker of (1) installed in the sample stand, and the measured concentration is adjusted to 5%. The measurement is continued until the number of measured particles reaches 50,000.

(7) The measurement data are analyzed with the dedicated software provided with the device, and the weight-average particle diameter (D4) is calculated. The weight-average particle diameter (D4) is the “average diameter” on the analysis/volume statistics (arithmetic mean) screen when graph/vol % is set using the dedicated software. The number-average particle diameter (D1) is the “average diameter” on the analysis/number statistics (arithmetic mean) screen when graph/number % is set using the dedicated software.

Measurement of Ratio (MX) of Number of Specific Metal Atoms to Sum of Numbers of Silicon Atoms and Specific Metal Atoms in Region Outside Contour of Toner Base Particle

### Preparation of Thin Toner Sample

The toner is spread on a cover glass (corner cover glasses square No. 1, commercially available from Matsunami Glass Ind., Ltd.) to form a single layer, and an Os film (5 nm) and a naphthalene film (20 nm) are applied to the toner as a protective film using an Osmium Plasma Coater (OPC80T, commercially available from Filgen). Next, a PTFE tube (inner diameter 1.5 mm×outer diameter 3 mm×3 mm) is filled with a photocurable resin D800 (commercially available from JEOL Ltd.), and the cover glass is gently placed on the tube so that the toner is in contact with the photocurable resin D800.

In this state, light is emitted to cure the resin, and the cover glass and the tube are then removed to form a cylindrical resin with the toner embedded in the outmost surface. Using an ultrasonic ultramicrotome (UC7, commercially available from Leica) at a cutting speed of 0.6 mm/s, the cylindrical resin is cut from the outmost surface by a length equal to the radius (4.0 μm when the weight-average particle size (D4) is 8.0 μm) of the toner to expose the cross-section of the toner. Next, cutting is performed to a film thickness of 100 nm to prepare a thin sample of the cross-section of the toner. By cutting in this manner, a cross-section of the center of the toner can be obtained.

### Observation of Cross-Section of Toner and EDS Analysis

The thin sample is observed in the STEM mode of a scanning transmission electron microscope (JEM2800, commercially available from JEOL Ltd.) connected to an EDS analysis device (energy dispersive X-ray analysis device) at a magnification of 400,000 in a field of view in which the outmost surface of the toner can be identified.

Spectrums of constituent elements of the observed cross-section of the toner are collected using an EDS analysis device to prepare an EDS mapping image. Spectrum collection and analysis are performed using NSS (commercially available from Thermo Fischer Scientific). Regarding the collection conditions, an accelerating voltage is 200 kV, a probe size of 1.0 nm or 1.5 nm is appropriately selected so that the dead time is from 15 to 30, the mapping resolution is 256×256, and the number of Frames is 500. EDS mapping images are obtained for 30 cross-sections of the toner.

### EDS Mapping Image Analysis

When the EDS mapping image obtained as described above is analyzed, the ratio of the number of specific metal atoms to the number of silicon atoms in the organosilicon polymer composite can be calculated.

First, a user presses an “Extract from line” button in NSS and selects the analysis range by freehand. Specifically, a baseline is drawn by tracing the interface between the toner base particle and the organosilicon polymer composite present at the surface of the toner base particle, and a parallel line is drawn at a position of 200 nm in the direction of the outline of the toner in parallel to the baseline. In this manner, the range between the baseline and the parallel line is selected as the analysis range, and this range is the region outside the contour of the toner base particle.

Once the analysis range of the toner has been selected, if the user presses a “Spectrum quantification” button, the silicon atom concentration and the specific metal atom concentration (atom %) in the selected range are automatically calculated. In this case, silicon and a specific metal element are selected as elements to be analyzed. Based on the values of the silicon atom concentration (atom %) and the specific metal atom concentration (atom %) displayed in the quantification results, the ratio MX of the number of specific metal atoms to the sum of the number of silicon atoms and the number of specific metal atoms in the organosilicon polymer composite can be calculated. Here, when two or more types of specific metal atoms are contained, the ratio of the sum of the numbers of these specific metal atoms to the sum of the numbers of silicon atoms and these specific metal atoms is calculated.

That is, MX=(sum of number of specific metal atoms)/(sum of numbers of silicon atoms and specific metal atoms). The arithmetic average value for 30 cross-sections of the toner is used.

### Number-Average Diameter of Domains of Metal Compound

In the same manner as in “Measurement of Ratio (MX) of Number of Specific Metal Atoms to Sum of Numbers of Silicon Atoms and Specific Metal Atoms in Region Outside Contour of Toner Base Particle”, a thin toner sample is prepared, the cross-section of the toner is observed and EDS analysis is performed.

### EDS Mapping Image Analysis (Calculation of Number-Average Diameter of Domains)

In the EDS mapping image of specific metal atoms obtained as described above, using image processing software “Image-Pro Plus (commercially available from Media Cybernetics),” the primary particle size is measured. First, using a straight line tool (Straight Line) on the toolbar, the scale bar displayed on the bottom of the STEM image is selected. In this state, when a user selects Set Scale in the Analyze menu, a new window opens, and the pixel distance of the selected straight line enters the Distance in Pixels box. When the user enters the scale bar value (for example, 100) in the Known Distance box of the window, enters the scale bar unit (nm) in the Unit of Measurement box, and clicks OK, scale setting is completed. Next, the contrast is adjusted so that only a specific metal compound is selected, and binarization is performed. The area A (nm²) of each domain of the specific metal compound on the obtained binarized image is calculated, and additionally, the diameter Dn (nm) of each domain is calculated by the following Formula (3). The above analysis operation is performed on the obtained 30 EDS mapping images.

$$D n = {( 4 A / π )}^{1 / 2} \qquad ( 3 )$$

Within the calculated domain diameters Dn, those with a diameter of 10 nm or more are extracted, and the average diameter thereof is used as the number-average diameter of the domains of the metal compound.

### Method of Identifying Organosilicon Polymer

The organosilicon polymer at the surface of the toner base particle is identified by comparing the ratio (Si/O ratio) of Si and O element contents (atom %) with that of a sample. EDS analysis is performed on each sample of the organosilicon polymer and the silica fine particle under conditions described in “Measurement of Ratio (MX) of Number of Specific Metal Atoms to Sum of Numbers of Silicon Atoms and Specific Metal Atoms in Region Outside Contour of Toner Base Particle”, and the atom concentrations (atom %) of silicon and oxygen are obtained. The ratio (Si/O) of the silicon atom concentration to the oxygen atom concentration in the organosilicon polymer is defined as A, and the ratio (Si/O) of the silicon atom concentration to the oxygen atom concentration in the silica fine particle is defined as B.

The sample is measured 10 times under the same conditions, and the arithmetic average values for A and B are obtained.

The cross-section of the toner is observed under conditions described in “Measurement of Ratio (MX) of Number of Specific Metal Atoms to Sum of Numbers of Silicon Atoms and Specific Metal Atoms in Region Outside Contour of Toner Base Particle”, and when the Si/O ratio of a part in which silicon is detected is a numerical value closer to A than to [(A+B)/2], the part is determined to be an organosilicon polymer. Tospearl 120A (commercially available from Momentive Performance Materials Japan LLC) is used as an organosilicon polymer particle sample, and HDK V15 (commercially available from Asahi Kasei Corporation) is used as a silica fine particle sample.

### Method of Identifying Titanium Dioxide Particle

Whether the metal compound is titanium dioxide is checked by performing EDS analysis under conditions described in “Measurement of Ratio (MX) of Number of Specific Metal Atoms to Sum of Numbers of Silicon Atoms and Specific Metal Atoms in Region Outside Contour of Toner Base Particle”. In the measured EDS mapping image, the user presses the “Extract from line” button in NSS and selects the range of the metal compound part by free hand. Once the analysis range of the toner has been selected, the user presses the “Spectrum quantification” button, and each atom concentration (atom %) in the selected range is automatically calculated. Identification is performed by comparing the ratio value (O/Ti) of the oxygen atom concentration (atom %) to the titanium atom concentration (atom %) displayed in the quantification results with that of a sample. The titanium dioxide sample used is CAS. No: 1317-80-2 (commercially available from FUJIFILM Wako Pure Chemical Corporation).

Method of Calculating Coverage Ratio of Toner Base Particles with Organosilicon Polymer Composite

The coverage ratio of the toner base particles with the organosilicon polymer composite is calculated when the external additive, the weakly fixed metal compound, and the organosilicon polymer are removed, and the toner surface image captured using a field emission scanning electron microscope (FE-SEM) is then processed.

Treatment of Removing External Additive from Toner Particles

160 g of sucrose (commercially available from Kishida Chemical Co., Ltd.) is added to 100 mL of deionized water and dissolved while heating in hot water to prepare a 61.5 mass % sucrose aqueous solution. 31.0 g of the sucrose aqueous solution and 6.0 g of Contaminon N (product name) (a 10.0 mass % aqueous solution of a neutral detergent for washing an accurate measuring instrument, containing a nonionic surfactant, an anionic surfactant and an organic builder and having a pH of 7, commercially available from Wako Pure Chemical Industries, Ltd.) are introduced into a centrifuge tube (50 mL) to prepare a dispersed solution. 1.0 g of the toner is added to this dispersed solution, and toner clumps are loosened with a spatula or the like. The centrifuge tube is shaken at 300 strokes per min (spm) with an amplitude of 4 cm for 20 minutes in a shaker (AS-IN, commercially available from As One Corporation) with a universal shaker option centrifuge tube holder (commercially available from As One Corporation) attached thereto. After shaking, the solution is transferred to a glass tube (50 mL) for a swing rotor, and separation is performed in a centrifugal machine under conditions of 3,500 rpm for 30 minutes. It is visually checked that the toner and the aqueous solution are sufficiently separated, and the toner separated to the top layer is collected with a spatula or the like. The collected toner is filtered using a vacuum filter and then dried in a dryer for 1 hour or longer. The dried product is deagglomerated with a spatula to obtain toner (a).

Treatment of Removing Weakly Fixed Metal Compound and Organosilicon Polymer from Toner Particles

31.0 g of the sucrose aqueous solution and 6.0 g of Contaminon N are introduced into a centrifuge tube to prepare a dispersed solution. 1.0 g of the toner that has been subjected to the treatment (a) is added to this dispersed solution, and toner clumps are loosened with a spatula or the like. Using VP-050 (commercially available from TAITEC), ultrasonic waves with an electrical output of 120 W are applied to the centrifuge tube for 10 minutes. After the ultrasonic treatment, the solution is transferred to a glass tube (50 mL) for a swing rotor, and separation is performed in a centrifugal machine under conditions of 3,500 rpm for 30 minutes. It is visually checked that the toner that has been subjected to the ultrasonic treatment and the aqueous solution are sufficiently separated, and the toner separated to the top layer is collected with a spatula or the like. The collected toner is filtered using a vacuum filter and then dried in a dryer for 1 hour or longer. The dried product is deagglomerated with a spatula to obtain toner (b).

The coverage ratio of the toner base particles with the organosilicon polymer composite is calculated by analyzing the toner surface image captured using a field emission scanning electron microscope S-4800 (commercially available from Hitachi High-Tech Corporation) using image analysis software Image-Pro Plus ver. 5.0 (commercially available from Nippon Roper Co., Ltd.). The image capturing method for S-4800 is as follows.

### (1) Sample Preparation

A conductive paste is thinly applied to a sample stage (aluminum sample stage 15 mm×6 mm), and the toner that has been subjected to the treatment (b) is sprayed thereonto. In addition, excess toner is removed from the sample stage by blowing air, and the sample is sufficiently dried. The sample stage is set in a sample holder, and the height of the sample stage is adjusted to 36 mm using a sample height gauge.

### (2) Setting S-4800 Observation Conditions

The coverage ratio is calculated using an image obtained by observing the backscattered electron image with S-4800. Since the backscattered electron image has less charge up of fine particles containing a metal compound than the secondary electron image, measurement can be performed with high accuracy. A liquid nitrogen is injected into an anti-contamination trap attached to the S-4800 housing until it overflows, and left for 30 minutes. The user starts “PC-SEM” S-4800 and performs flushing (cleaning an FE chip which is an electron source). The user clicks the accelerating voltage display unit on the control panel on the screen, presses a [Flushing] button, and opens the flushing execution dialog. The user checks that the flushing intensity is 2 and executes flushing. It is confirmed that the emission current due to flushing is 20 to 40 μA. The sample holder is inserted into the sample chamber of the S-4800 housing. The user presses [Origin] on the control panel to move the sample holder to the observation position.

The user clicks the accelerating voltage display unit to open the HV settings dialog and sets the accelerating voltage to [0.8 kV], and the emission current to [20 μA]. In the [Basic] tab on the operation panel, the user sets the signal selection to [SE], selects [upper (U)] and [+BSE] for the SE detector, and selects [L. A. 100] in the selection box on the right of [+BSE], and sets the mode to observation with the backscattered electron image. In the same [Basic] tab on the operation panel, the probe current in the electron optical system condition block is set to [Normal], the focus mode is set to [UHR], and WD is set to [3.0 mm]. The user presses an [ON] button on the accelerating voltage display unit on the control panel and applies the accelerating voltage.

### (3) Adjustment of Aperture Alignment

The user drags within the magnification display unit on the control panel and sets the magnification to 5,000 (5 k). The user rotates the focus knob [COARSE] on the operation panel and adjusts the aperture alignment when the image is in focus to a certain extent. The user clicks [Align] on the control panel to display the alignment dialog and selects [Beam]. The user rotates STIGMA/ALIGNMENT knobs (X, Y) on the operation panel to move the displayed beam to the center of the concentric circles. Next, the user selects [Aperture], and turns the STIGMA/ALIGNMENT knobs (X, Y) one by one to perform adjustment so that image movement is stopped or there is minimal movement. The user closes the aperture dialog and adjusts the focus according to auto focus. This operation is additionally repeated twice to adjust the focus.

### (4) Focus Adjustment

The user drags within the magnification display unit on the control panel and sets the magnification to 10,000 (10 k). The user rotates the focus knob [COARSE] on the operation panel and adjusts again aperture alignment when the image is in focus to a certain extent. The user clicks [Align] on the control panel to display the alignment dialog and selects [Beam]. The user rotates STIGMA/ALIGNMENT knobs (X,Y) on the operation panel to move the displayed beam to the center of the concentric circles. Next, the user selects [Aperture], and turns the STIGMA/ALIGNMENT knobs (X, Y) one by one to perform adjustment so that image movement is stopped or there is minimal movement. The user closes the aperture dialog and adjusts the focus according to auto focus. Then, the user sets the magnification to 50,000 (50 k), performs focus adjustment using the focus knob and STIGMA/ALIGNMENT knobs in the same manner as above, and adjusts again the focus according to auto focus. This operation is repeated again to adjust the focus. Here, when the inclination angle of the observation surface is large, since the measurement accuracy of the coverage ratio tends to be low, an object with as little surface inclination as possible is selected for analysis by selecting one in which the entire observation surface is in focus at the same time during focus adjustment.

### (5) Image Saving

Brightness is adjusted in the ABC mode, and an image with a size of 640×480 pixels is captured and saved. The following analysis is performed using this image file. One image is captured for each toner particle, and images for at least 30 or more toner particles are obtained.

### (6) Image Analysis

The coverage ratio is calculated by binarizing the image obtained by the above method using the following analysis software. In this case, the above one screen is divided into 12 squares, and each square is analyzed. Analysis conditions for the image analysis software Image-Pro Plus ver. 5.1J (commercially available from Media Cybernetics) are as follows.

The user selects “Measurement” on the software Image-ProPlus 5.1J toolbar and then “Count/size,” and “Options” in that order and sets binarization conditions. The user selects 8-connection from the object extraction options and sets smoothing to 0. In addition, the user does not select pre-select, fill gaps, or enclosing line, and sets “Exclude boundary line” to “None.” The user selects “Measurement item” from “Measurement” on the toolbar and enters 2 to 107 in the area selection range. In order to calculate the coverage ratio, the square region is enclosed and analysis is performed. In this case, the area (C) of the region is composed of 25,000 pixels. Automatic binarization is performed from “Treatment”-binarization. When binarized, the organosilicon polymer composite appears as a white contrast, and the surface of the toner base particle appears as a black contrast. The total area (D) of the surface of the toner base particles is calculated. The coverage ratio a is obtained using the following formula from the area C of the square region and the total area D of the surface of the toner base particle.

$$Coverage ratio a ( \% ) = 100 - ( ( D / C ) \times 100 )$$

As described above, the coverage ratio a is calculated for 30 or more toner particles that have been subjected to the treatment (b). The average value of all of the obtained data items is used as the coverage ratio.

### EXAMPLES

The present disclosure will be described in detail with reference to the following examples. However, the present invention is not limited to these examples. Unless otherwise specified, in the formulations of examples and comparative examples, “parts” and “%” are all based on the mass.

### Production Example of Toner Base Particle Dispersed Solution 1

11.2 parts of sodium phosphate (12-hydrate) was introduced into a reaction container containing 390.0 parts of deionized water, and the mixture was kept at 65° C. for 1.0 hours while purging with nitrogen. The mixture was stirred using a T. K. homomixer (commercially available from Tokushu Kika Kogyo Co., Ltd.) at 12,000 rpm. While maintaining stirring, a calcium chloride aqueous solution obtained by dissolving 7.4 parts of calcium chloride (dihydrate) in 10.0 parts of deionized water was introduced into the reaction container at once to prepare an aqueous medium containing a dispersion stabilizer. In addition, 1.0 mol/L hydrochloric acid was introduced into the aqueous medium in the reaction container, the pH was adjusted to 6.0, and thereby an aqueous medium 1 was prepared.

### Preparation of Polymerizable Monomer Composition

| | |
|---|---|
| Styrene | 60.0 parts |
| C.I. Pigment Blue 15:3 | 6.3 parts |

The materials were introduced into an attritor (commercially available from Nippon Coke & Engineering Co., Ltd.), and additionally dispersed using zirconia particles with a diameter of 1.7 mm at 220 rpm for 5.0 hours to prepare a colorant dispersed solution in which the pigment was dispersed.

Next, the following materials were added to the colorant dispersed solution.

| | |
|---|---|
| Styrene | 15.0 parts |
| n-Butyl acrylate | 25.0 parts |
| Polyester resin (Polycondensation product of terephthalic | 5.0 parts |
| acid and bisphenol A propylene oxide (2 mol) adduct, | |
| weight-average molecular weight Mw = 10,000, acid value: | |
| 8.2 mg KOH/g) | |
| HNP9 (melting point: 76° C., commercially available | 6.0 parts |
| from Nippon Seiro Co., Ltd.) | |

The materials were kept at 65° C. and uniformly dissolved and dispersed using a T. K. homomixer at 500 rpm to prepare a polymerizable monomer composition.

### Granulation Step

While maintaining the temperature of the aqueous medium 1 at 70° C. and the rotation speed of the stirring device at 12,500 rpm, the polymerizable monomer composition was introduced into the aqueous medium 1 and 8.0 parts of t-butyl peroxypivalate as a polymerization initiator was added. The mixture was directly granulated for 10 minutes while maintaining 12,500 rpm in the stirring device.

### Polymerization Step

The high-speed stirring device was changed to a stirring machine including a propeller stirring blade, and while stirring at 200 rpm and maintaining 70° C., polymerization was performed for 5.0 hours, the temperature was additionally raised to 85° C., and heating was performed for 2.0 hours to cause a polymerization reaction. In addition, the temperature was raised to 98° C., heating was performed for 3.0 hours to remove residual monomers, deionized water was added to adjust the toner base particle concentration in the dispersed solution to 30.0 mass %, and thereby a toner base particle dispersed solution 1 in which toner base particles 1 were dispersed was obtained. The number-average particle size (D1) of the toner base particles 1 was 6.2 μm, and the weight-average particle size (D4) thereof was 6.9 μm.

### Production Example of Toner Base Particle Dispersed Solution 2

11.2 parts of sodium phosphate (12-hydrate) was introduced into a reaction container containing 390.0 parts of deionized water, and the mixture was kept at 65° C. for 1.0 hours while purging with nitrogen. The mixture was stirred using a T. K. homomixer (commercially available from Tokushu Kika Kogyo Co., Ltd.) at 12,000 rpm. While maintaining stirring, a calcium chloride aqueous solution obtained by dissolving 7.4 parts of calcium chloride (dihydrate) in 10.0 parts of deionized water was introduced into the reaction container at once to prepare an aqueous medium containing a dispersion stabilizer. In addition, 1.0 mol/L hydrochloric acid was introduced into the aqueous medium in the reaction container, the pH was adjusted to 6.0, and thereby an aqueous medium 2 was prepared.

A toner base particle dispersed solution 2 was obtained in the same manner as in the production example of the toner base particle dispersed solution 1 except that the aqueous medium 2 was used in place of the aqueous medium 1. The number-average particle size (D1) of the toner base particles 2 was 5.2 μm, and the weight-average particle size (D4) thereof was 6.7 μm.

### Production Example of Toner Particles 1

### Organosilicon Polymer Hydrolysis Step

60.0 parts of deionized water was weighed out into a reaction container including a stirring machine and a thermometer, and the pH was adjusted to 4.0 using 10 mass % hydrochloric acid. This sample was heated with stirring and the temperature was set to 40° C. Then, 40.0 parts of methyltriethoxysilane as an organosilicon compound and 1.50 parts of titanium dioxide (average primary particle size of 30 nm) were added, and the mixture was stirred for 2 hours or longer to cause hydrolysis. The end point of hydrolysis was visually confirmed when the oil and water were not separated but formed into a single layer, the mixture was cooled to obtain a composite solution containing an organosilicon compound hydrolysate and titanium dioxide (referred to as a composite solution 1).

### Organosilicon Polymer Composite Formation Step

After the temperature of the toner base particle dispersed solution 1 was lowered to 55° C., 13.5 parts of the composite solution 1 was added to 500 parts of the toner base particle dispersed solution 1 to initiate polymerization of the organosilicon compound. After the mixture was maintained for 15 minutes without change, the pH was adjusted to 5.5 with a 3.0% sodium bicarbonate aqueous solution. The mixture was kept at 55° C. for 60 minutes while continuing to stir, the pH was then adjusted to 9.5 using a 3.0% sodium bicarbonate aqueous solution, and the mixture was additionally maintained for 240 minutes to obtain a toner particle-dispersed solution 1.

### Washing and Drying Step

After the organosilicon polymer composite formation step was completed, the toner particle-dispersed solution 1 was cooled, hydrochloric acid was added to the toner particle-dispersed solution 1 to adjust the pH to 1.5 or less, and the mixture was left for 1 hour with stirring and then subjected to solid/liquid separation using a pressure filter to obtain a toner cake. This was subjected to re-slurry in deionized water to form a dispersed solution again, and the solution was then subjected to solid/liquid separation using the above filter to obtain a toner cake. The obtained toner cake was dried in a thermostatic chamber at 40° C. for 72 hours and classified to obtain toner particles 1. Table 3 shows the physical properties of the toner particles 1.

### Production Example of Toner Particles 2 to 22

Composite solutions containing an organosilicon compound hydrolysate and titanium dioxide (composite solutions 2 to 22) were obtained in the same manner as in the production example of the toner particles 1 except that the types and contents of raw materials in (organosilicon polymer hydrolysis step) were changed as shown in Table 1.

Next, toner particle-dispersed solutions 2 to 22 were obtained in the same manner as in the production example of the toner particles 1 except that the type, content and final pH of the composite solution in (organosilicon polymer composite formation step) were changed as shown in Table 2.

The obtained toner particles-dispersed solutions 2 to 22 each were treated in the same manner as in the production example of the toner particles 1 (washing and drying step) to obtain toner particles 2 to 22. Table 3 shows the physical properties thereof.

### Production Example of Toner Particles 23

### Organosilicon Polymer Hydrolysis Step

80.0 parts of deionized water was weighed out into a reaction container including a stirring machine and a thermometer, and the pH was adjusted to 3.5 using 10 mass % hydrochloric acid. This sample was heated with stirring and the temperature was set to 60° C. Then, 20.0 parts of methyltriethoxysilane as an organosilicon compound was added and stirred for 1 hour to obtain an organosilicon polymer hydrolyzed solution.

### Organosilicon Polymer Composite Formation Step

The following samples were weighed out into a reaction container and mixed using a propeller stirring blade.

| | |
|---|---|
| Toner base particle dispersed solution 2 | 500.0 parts |
| Organosilicon compound hydrolyzed solution | 9.0 parts |
| Titanium lactate 44% aqueous solution | 1.82 parts (equivalent |
| (TC-310: commercially available from | to 0.80 parts of |
| Matsumoto Fine Chemical Co., Ltd.) | titanium lactate) |

Next, the pH of the mixed solution was adjusted to 7.0 using a 1 mol/L NaOH aqueous solution, and the temperature was set to 50° C. and then maintained for 1 hour. Then, the pH was adjusted to 9.5 using a 1 mol/L NaOH aqueous solution and maintained for 2.0 hours with stirring.

Next, 1.0 mol/L hydrochloric acid was introduced to adjust the pH of the mixed solution to 7.0. After 17.5 parts of the organosilicon compound hydrolyzed solution was additionally added, the pH was adjusted to 9.5 using a 1 mol/L NaOH aqueous solution and maintained for 2.0 hours with stirring to obtain a toner particle-dispersed solution 23.

The same (washing and drying step) as in the production example of the toner particle-dispersed solution 1 was performed to obtain toner particles 23. Here, the toner particles 23 had a titanium phosphate compound and an organosilicon polymer in an organosilicon polymer composite, and the titanium phosphate compound was a reaction product of titanium lactate and phosphate ions derived from sodium phosphate or calcium phosphate in the aqueous medium 2. Table 3 shows the physical properties of the toner particles 23.

### Production Example of Toner Particles 24

The toner base particle dispersed solution 1 was used as a toner particle-dispersed solution 24 without forming an organosilicon polymer composite, which was washed and dried in the same manner as in the production example of the toner particles 1 to obtain toner particles 24.

### Production Example of Toner 24

| | |
|---|---|
| Toner particles 24 | 100.0 parts |
| Titanium dioxide particles (average primary | 0.035 parts |
| particle size 30 nm) | |
| Hydrophobic silica fine particles subjected to | 1.00 part |
| a surface treatment with a dimethyl silicone | |
| oil (Average primary particle size: 7 nm) | |

The materials were introduced into SUPERMIXER PICCOLO SMP-2 (commercially available from Kawata MFG Co., Ltd.) and mixed at 3,000 rpm for 20 minutes. Then, the mixture was sieved through a mesh having an opening of 150 μm to obtain toner 24.

TABLE 1

| | Organosilicon compound | | Metal compound | | |
|---|---|---|---|---|---|
| | | Content | | Content | Particle |
| | Type | (parts by mass) | Type | (parts by mass) | size (nm) |
| Composite solution 1 | methyltriethoxysilane | 40 | titanium dioxide | 1.50 | 30 |
| Composite solution 2 | methyltriethoxysilane | 22 | titanium dioxide | 1.50 | 30 |
| Composite solution 3 | methyltriethoxysilane | 55 | titanium dioxide | 1.50 | 30 |
| Composite solution 4 | methyltriethoxysilane | 20 | titanium dioxide | 1.50 | 30 |
| Composite solution 5 | methyltriethoxysilane | 59 | titanium dioxide | 1.50 | 30 |
| Composite solution 6 | methyltriethoxysilane | 40 | titanium phosphate | 2.00 | 35 |
| Composite solution 7 | methyltriethoxysilane | 54 | alumina | 1.50 | 35 |
| Composite solution 8 | methyltriethoxysilane | 40 | zirconia | 1.50 | 30 |
| Composite solution 9 | methyltriethoxysilane | 40 | titanium dioxide | 3.26 | 30 |
| Composite solution 10 | methyltriethoxysilane | 40 | titanium dioxide | 3.38 | 30 |
| Composite solution 11 | methyltriethoxysilane | 40 | titanium dioxide | 0.83 | 30 |
| Composite solution 12 | methyltriethoxysilane | 40 | titanium dioxide | 0.75 | 30 |
| Composite solution 13 | methyltriethoxysilane | 40 | titanium dioxide | 1.50 | 30 |
| Composite solution 14 | methyltriethoxysilane | 40 | titanium dioxide | 3.38 | 20 |
| Composite solution 15 | methyltriethoxysilane | 40 | titanium dioxide | 3.38 | 50 |
| Composite solution 16 | methyltriethoxysilane | 40 | titanium dioxide | 4.05 | 80 |
| Composite solution 17 | methyliriethoxysilane | 40 | titanium dioxide | 1.50 | 80 |
| Composite solution 18 | methyltriethoxysilane | 40 | titanium dioxide | 0.41 | 15 |
| Composite solution 19 | methyltriethoxysilane | 40 | titanium dioxide | 5.25 | 15 |
| Composite solution 20 | methyltriethoxysilane | 40 | titanium dioxide | 0.38 | 15 |
| Composite solution 21 | methyltriethoxysilane | 40 | titanium dioxide | 5.63 | 30 |
| Composite solution 22 | methyltriethoxysilane | 40 | None | — | — |

TABLE 2

| | Organosilicon polymer composite formation step | | |
|---|---|---|---|
| | Type of composite | Content (parts | Final |
| | solution | by mass) | pH |
| Toner particle dispersed solution 1 | Composite solution 1 | 13.5 | 9.5 |
| Toner particle dispersed solution 2 | Composite solution 2 | 11.0 | 10.5 |
| Toner particle dispersed solution 3 | Composite solution 3 | 15.5 | 9.5 |
| Toner particle dispersed solution 4 | Composite solution 4 | 11.0 | 10.5 |
| Toner particle dispersed solution 5 | Composite solution 5 | 16.0 | 9.5 |
| Toner particle dispersed solution 6 | Composite solution 6 | 13.5 | 9.5 |
| Toner particle dispersed solution 7 | Composite solution 7 | 13.5 | 9.5 |
| Toner particle dispersed solution 8 | Composite solution 8 | 13.5 | 9.5 |
| Toner particle dispersed solution 9 | Composite solution 9 | 13.8 | 9.5 |
| Toner particle dispersed solution 10 | Composite solution 10 | 13.5 | 9.5 |
| Toner particle dispersed solution 11 | Composite solution 11 | 13.5 | 9.5 |
| Toner particle dispersed solution 12 | Composite solution 12 | 13.5 | 9.5 |
| Toner particle dispersed solution 13 | Composite solution 13 | 13.5 | 9.5 |
| Toner particle dispersed solution 14 | Composite solution 14 | 13.5 | 9.5 |
| Toner particle dispersed solution 15 | Composite solution 15 | 13.5 | 9.5 |
| Toner particle dispersed solution 16 | Composite solution 16 | 13.5 | 9.5 |
| Toner particle dispersed solution 17 | Composite solution 17 | 13.5 | 9.5 |
| Toner particle dispersed solution 18 | Composite solution 18 | 13.5 | 9.5 |
| Toner particle dispersed solution 19 | Composite solution 19 | 14.0 | 9.5 |
| Toner particle dispersed solution 20 | Composite solution 20 | 14.0 | 9.5 |
| Toner particle dispersed solution 21 | Composite solution 21 | 16.0 | 9.5 |
| Toner particle dispersed solution 22 | Composite solution 22 | 13.5 | 9.5 |

TABLE 3

| | | | | | Coverage ratio (%) of |
|---|---|---|---|---|---|
| | | | | | toner base particles with |
| | | ME | MX | MN (nm) | organosilicon polymer composite |
| Toner particle 1 | Toner particle dispersed solution 1 | 5.0E−03 | 3.71E−02 | 30 | 58 |
| Toner particle 2 | Toner particle dispersed solution 2 | 8.0E−03 | 6.80E−02 | 30 | 35 |
| Toner particle 3 | Toner particle dispersed solution 3 | 2.8E−03 | 2.72E−02 | 30 | 70 |
| Toner particle 4 | Toner particle dispersed solution 4 | 9.3E−03 | 7.55E−02 | 30 | 32 |
| Toner particle 5 | Toner particle dispersed solution 5 | 3.0E−03 | 2.55E−02 | 30 | 73 |
| Toner particle 6 | Toner particle dispersed solution 6 | 9.5E−03 | 3.71E−02 | 35 | 56 |
| Toner particle 7 | Toner particle dispersed solution 7 | 4.2E−03 | 2.93E−02 | 30 | 60 |
| Toner particle 8 | Toner particle dispersed solution 8 | 4.5E−03 | 3.71E−02 | 30 | 63 |
| Toner particle 9 | Toner particle dispersed solution 9 | 9.4E−03 | 8.07E−02 | 30 | 59 |
| Toner particle 10 | Toner particle dispersed solution 10 | 1.0E−02 | 8.34E−02 | 30 | 58 |
| Toner particle 11 | Toner particle dispersed solution 11 | 2.0E−03 | 2.04E−02 | 30 | 57 |
| Toner particle 12 | Toner particle dispersed solution 12 | 2.2E−03 | 1.85E−02 | 30 | 60 |
| Toner particle 13 | Toner particle dispersed solution 13 | 1.3E−02 | 3.71E−02 | 20 | 56 |
| Toner particle 14 | Toner particle dispersed solution 14 | 4.6E−03 | 8.34E−02 | 50 | 55 |
| Toner particle 15 | Toner particle dispersed solution 15 | 4.2E−03 | 8.34E−02 | 80 | 59 |
| Toner particle 16 | Toner particle dispersed solution 16 | 4.2E−03 | 1.00E−01 | 80 | 60 |
| Toner particle 17 | Toner particle dispersed solution 17 | 1.5E−02 | 3.71E−02 | 15 | 61 |
| Toner particle 18 | Toner particle dispersed solution 18 | 5.0E−03 | 1.00E−02 | 15 | 60 |
| Toner particle 19 | Toner particle dispersed solution 19 | 1.7E−02 | 1.30E−01 | 15 | 58 |
| Toner particle 20 | Toner particle dispersed solution 20 | 1.1E−03 | 9.27E−03 | 30 | 60 |
| Toner particle 21 | Toner particle dispersed solution 21 | 1.2E−02 | 9.56E−02 | 100 | 72 |
| Toner particle 22 | Toner particle dispersed solution 22 | 0 | 0 | 0 | 64 |
| Toner particle 23 | Toner particle dispersed solution 23 | 2.6E−02 | 4.87E−02 | 13 | 0 |
| Toner particle 24 | Toner particle dispersed solution 24 | 3.5E−02 | 6.21E−02 | 30 | — |

In the tables, for example, the description 5.0E-03 indicates 5.0×10⁻³.

### Example 1

The following evaluations were performed using the toner particles 1 without change as the toner 1. The evaluation results are shown in Table 4.

Evaluation 1; Evaluation of Fogging when Talc was Mixed in

The evaluation was performed using a commercially available color laser printer (Hp Laserjet Enterprise Color M553dn) having a potential difference between a charging blade and a developing roller. In addition, the toner was removed from the black toner cartridge, and 300 g of the toner 1 and 0.3 g (0.1 wt % relative to the toner) of talc powder (general-purpose talc “PA-OG,” commercially available from Nippon Talc Co., Ltd.) were filled. In this evaluation, when talc was intentionally mixed in the cartridge, a situation that may occur in a cleanerless system was reproduced. When talc was mixed in, since the triboelectric charging performance of the toner decreased, an environment in which charge control was stricter was created. Such a cartridge was attached to a black station, a dummy cartridge was attached to another station, and they left for 3 days in an environment of 30.0° C./80% RH.

XEROX4200 paper (75 g/m², commercially available from XEROX) was set as media in the above printer, and at 30.0° C./80% RH, using a paper with a sticky note attached to mask a part of the printed surface of the image, a full white image was output (white image 1). Then, 10,000 sheets of a character pattern image with a print percentage of 4% were printed. After 10,000 sheets were printed, again, using a paper with a sticky note attached to mask a part of the printed surface of the image, a full white image was output (white image 2). After printing, the toner was consumed, the talc concentration in the cartridge increased, and thus charge control became more difficult.

After the sticky note was removed from the white image 1, the reflectance (%) was measured at five points on a part with a sticky note attached and a part with no sticky note attached respectively, the average value thereof was obtained, the difference in the average value (a part with a sticky note attached−a part with no sticky note attached) was obtained, and this was used as the initial fogging. In addition, similarly, for the white image 2, the difference in the average value was obtained and this was used as fogging after endurance

### Evaluation Criteria

A: the difference in the average value was less than 0.5%
B: the difference in the average value was 0.5% or more and less than 1.5%
C: the difference in the average value was 1.5% or more and less than 3.0%
D: the difference in the average value was 3.0% or more
   Evaluation 2; Evaluation of Ghosting when Talc was Mixed in

After the white image 2 of Evaluation 1 was output, one ghost determination image was output. The ghost determination image was an image in which seven solid images of 15 mm×15 mm were arranged in a horizontal row at 15 mm intervals at a position 5 mm from the upper end of the paper, and parts below these solid images were halftone images with a toner loading amount of 0.20 mg/cm². The concentration difference caused by the 15 mm×15 mm solid image in the halftone part of the image was visually determined.

### Evaluation Criteria

A: no difference in shading was observed
B: very slight difference in shading was observed
C: slight difference in shading was observed
D: clear difference in shading was observed
   Evaluation 3; Evaluation of Development Streaks when Amount of Deformed Toner Increased

A commercially available color laser printer (Hp Laserjet Enterprise Color M553dn) having a potential difference between a charging blade and a developing roller was modified, and the process speed was set to 270 mm/s. The toner was removed from the black toner cartridge, and 80 g of the toner 1 was filled. Such a cartridge was attached to a black station, a dummy cartridge was attached to another station, and they left for 3 days in an environment of 15.0° C./10% RH.

XEROX4200 paper (75 g/m², commercially available from XEROX) was set as media in the above printer, and at 15.0° C./10% RH, 5,000 sheets of a character pattern image with a print percentage of 2% were printed. In this case, when printing was performed in a mode in which the number of sheets per job was two and the machine was set to pause between jobs before the next job started, the number of times the toner was rubbed increased. After printing 5,000 sheets, 80 g of the toner 1 was additionally filled, and 5,000 sheets were additionally printed (a total of 10,000 sheets).

In this evaluation, by intentionally increasing the number of times the toner was rubbed and increasing the amount of the deformed toner in the developing apparatus, a situation that may occur in the cleanerless system was reproduced. After 10,000 sheets were printed, a full black image with a toner loading amount of 0.40 mg/cm² was output, and whether streaks (development streaks) occurred on the image was checked. Then, images with a print percentage of 2% were continuously output, and whenever 1,000 sheets were output, a full black image was output to check whether development streaks occurred.

### Evaluation Criteria

A: no development streaks occurred after 14,000 sheets were output
B: development streaks occurred after more than 13,000 sheets and 14,000 sheets or less were output
C: development streaks occurred after 11,000 sheets or more and 13,000 sheets or less were output
D: development streaks occurred after less than 11,000 sheets were output

### Examples 2 to 18 and Comparative Examples 1 to 6

The image output test was performed in the same manner as in Example 1 except that the toner was changed as shown in Table 4, and evaluation was performed. The evaluation results are shown in Table 4.

TABLE 4

| | | | Evaluation 1 | | | | Evaluation | Evaluation |
|---|---|---|---|---|---|---|---|---|
| | | | Initial | | After | | 2 | 3 |
| | | | Rank | Value | Rank | Value | Rank | Rank |
| Example 1 | Toner 1 | Toner particle 1 | A | 0.2% | A | 0.3% | A | A |
| Example 2 | Toner 2 | Toner particle 2 | A | 0.3% | A | 0.4% | A | A |
| Example 3 | Toner 3 | Toner particle 3 | A | 0.4% | A | 0.3% | A | A |
| Example 4 | Toner 4 | Toner particle 4 | A | 0.3% | A | 0.2% | B | A |
| Example 5 | Toner 5 | Toner particle 5 | A | 0.4% | A | 0.3% | A | B |
| Example 6 | Toner 6 | Toner particle 6 | A | 0.2% | A | 0.3% | B | A |
| Example 7 | Toner 7 | Toner particle 7 | A | 0.3% | A | 0.4% | B | B |
| Example 8 | Toner 8 | Toner particle 8 | A | 0.4% | A | 0.4% | B | B |
| Example 9 | Toner 9 | Toner particle 9 | A | 0.4% | B | 0.5% | A | A |
| Example 10 | Toner 10 | Toner particle 10 | A | 0.3% | B | 0.8% | B | A |
| Example 11 | Toner 11 | Toner particle 11 | A | 0.3% | B | 0.7% | A | A |
| Example 12 | Toner 12 | Toner particle 12 | A | 0.3% | B | 0.9% | B | A |
| Example 13 | Toner 13 | Toner particle 13 | A | 0.4% | B | 1.2% | B | B |
| Example 14 | Toner 14 | Toner particle 14 | A | 0.2% | B | 1.3% | B | B |
| Example 15 | Toner 15 | Toner particle 15 | B | 0.9% | B | 1.3% | B | B |
| Example 16 | Toner 16 | Toner particle 16 | C | 1.6% | C | 2.5% | B | B |
| Example 17 | Toner 17 | Toner particle 17 | C | 1.8% | C | 2.6% | C | B |
| Example 18 | Toner 18 | Toner particle 18 | B | 1.3% | C | 2.4% | C | C |
| Comparative | Toner 19 | Toner particle 19 | C | 1.7% | D | 3.1% | D | D |
| example 1 | | | | | | | | |
| Comparative | Toner 20 | Toner particle 20 | C | 2.5% | D | 3.0% | D | D |
| example 2 | | | | | | | | |
| Comparative | Toner 21 | Toner particle 21 | D | 3.5% | D | 4.5% | D | D |
| example 3 | | | | | | | | |
| Comparative | Toner 22 | Toner particle 22 | D | 3.4% | D | 5.2% | D | D |
| example 4 | | | | | | | | |
| Comparative | Toner 23 | Toner particle 23 | C | 2.9% | D | 4.9% | C | C |
| example 5 | | | | | | | | |
| Comparative | Toner 24 | Toner particle 24 | C | 2.8% | D | 3.2% | D | C |
| example 6 | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-151573, filed Sep. 19, 2023, which is hereby incorporated by reference herein in its entirety.

What is claimed is:

1. A toner comprising a toner particle, wherein
the toner particle comprises
a toner base particle comprising a binder resin, and
an organosilicon polymer composite present at a surface of the toner base particle,
the organosilicon polymer composite comprises
(i) a condensation product of an organosilicon compound, and
(ii) a metal compound comprising at least one metal atom selected from the group consisting of aluminum, zirconium and titanium,
when a ratio of the number of the metal atom to a sum of the numbers of a carbon atom, an oxygen atom, a silicon atom, and the metal atom obtained by X-ray photoelectron spectroscopy on the toner is defined as ME,
in an EDS mapping image of constituent elements of a cross-section of the toner obtained by analyzing with use of energy dispersive X-ray spectroscopy, the cross-section of the toner observed with a transmission electron microscope, a ratio of the number of the metal atom to a sum of the numbers of a silicon atom and the metal atom in a region outside a contour of the toner base particle is defined as MX, and
in the EDS mapping image, in a case where there are domains of the metal compound, and domains with a domain diameter of 10 nm or more are targeted, the number-average diameter of the domains of the metal compound is defined as MN,
ME is not more than 1.5×10⁻²,
MX is 1.00×10⁻² to 1.00×10⁻¹, and
MN is 15 to 80 nm.

2. The toner according to claim 1, wherein
MN is 20 to 50 nm.

3. The toner according to claim 1, wherein
ME is not more than 1.0×10⁻², and
MX is 2.00×10⁻² to 8.00×10⁻².

4. The toner according to claim 1, wherein
a coverage ratio of the toner base particle with the organosilicon polymer composite is 35 to 70 area %.

5. The toner according to claim 1, wherein
the condensation product of the organosilicon compound is an organosilicon polymer having a structure represented by Formula (I) below:
R—SiO_{3/2} (I)
in Formula (I), R is an alkyl group, alkenyl group, acyl group, aryl group or methacryloxyalkyl group.

6. The toner according to claim 1, wherein the metal atom is titanium.

7. The toner according to claim 1, wherein
the metal compound is at least one metal compound selected from the group consisting of titanium dioxide and reaction products of titanium with polyhydric acids.

8. The toner according to claim 1, wherein the metal compound is titanium dioxide.
